(19) United States
(12) Patent Application Publication
(10) Pub. No.: US 2005/0232336 A1
(43) Pub. Date: Oct. 20, 2005

(54) Versatile system for signal shaping in ultra-wideband communications

(76) Inventors: Jaiganesh Balakrishnan, Bangalore (IN); Srinivas Lingam, Richardson, TX (US); Anuj Batra, Dallas, TX (US)

Correspondence Address: TEXAS INSTRUMENTS INCORPORATED, P O BOX 655474, M/S 3999, DALLAS, TX, 75265, US

(21) Appl. No.: 11/109,334

(22) Filed: Apr. 19, 2005

Related U.S. Application Data
(60) Provisional application No. 60/564,327, filed on Apr. 20, 2004.

(51) Int. Cl. H04B 1/69

(52) U.S. Cl. 375/130

(57) ABSTRACT

The present invention provides a versatile system for selectively altering or shaping transmission signals in an ultra-wideband communications system (100). The system provides a serial to parallel conversion function (102) with a serial data input (116). The serial to parallel conversion function converts the serial data and outputs it in parallel format. An adjustment function (104) receives the now parallel data and selectively alters the parallel data responsive to some code or vector (118). A frequency-to-time-domain conversion function (106) receives the selectively altered parallel data and transmits it to a parallel-to-serial conversion function 108. The now serial data transfer through an OFDM prefix/suffix function 110 and a digital-to-analog conversion function 112, to an up conversion mixer function 114. Encoded digital data bits are input, converted to parallel format, and passed to the spectrum adjustment function, which provides selective adjustment of specific data units (i.e., specific OFDM sub-carriers or tones).

### PRIORITY CLAIM

This application claims priority of U.S. Provisional Application No. 60/564,327, filed Apr. 20, 2004.

### TECHNICAL FIELD OF THE INVENTION

The present invention relates generally to the field of wireless communications and, more particularly, to structures and methods for maximizing utilization and efficiency of ultra-wideband communications through pre-transmission signal shaping.

### BACKGROUND OF THE INVENTION

Increasing demand for more powerful and convenient data and information communication has spawned a number of advancements in communications technologies, particularly in wireless communication technologies. A number of technologies have been developed to provide the convenience of wireless communication in a variety of applications, in various locations. This proliferation of wireless communication has given rise to a number of manufacturing and operational considerations.

Since wireless communications rely on over-the-air (OTA) transmissions, wireless systems and their operation are subjected to a number of regulatory requirements and restrictions. These regulatory influences can vary considerably, and even conflict, across different countries or regions. Wireless device manufacturers and service providers often develop industrial standards to define specific communication schemes, and to help reconcile competing or conflicting approaches thereto.

Among the emerging communication technologies, ultra-wideband (UWB) technology is gaining support and acceptance for wireless transmission of video, audio or other high bandwidth data between various devices. Generally, UWB is utilized for short-range radio communications—typically data relay between devices within approximately 30 feet—although longer-range applications may be developed. A conventional UWB transmitter operates a very wide spectrum of frequencies, several GHz in bandwidth. UWB may be defined as radio technology that has either: 1) a spectrum that occupies bandwidth greater than 20% of its center frequency; or, as it is more commonly understood, 2) a bandwidth ≧500 MHz.

UWB systems often use some modulation scheme, such as Orthogonal Frequency Division Multiplexing (OFDM), to organize or allocate data transmissions across these extremely wide bandwidths. This approach is frequently supplemented with the use of multiple bands, in combination with OFDM modulation. Multi-band OFDM thus provides relatively low-power, broad-spectrum communication that enables high bandwidth data transfer.

In the United States, the Federal Communications Commission (FCC) has allocated the spectrum from 3.1 GHz-10.6 GHz for UWB radio transmissions. This UWB frequency allocation is unlicensed, leaving the spectrum open to a number of potentially conflicting technologies.

Due to this unlicensed nature, UWB devices and systems have to contend with both pre-existing and future-developed services that share some portion of that frequency range. In order to enable co-existence in the United States, therefore, UWB systems should be capable of selectively limiting transmissions in certain spectral sub-ranges. Furthermore, compliance with global regulatory standards may require conformance to, for example, regionally dependent spectral limitations. Therefore, unless a manufacturer produces regional or country-specific products, they must find a way to make their wireless devices adaptable to a variety of worldwide, location-specific limitations that may or may not overlap or conflict with one another.

Moreover, the relative strength (i.e., power) of UWB signals is also limited to a transmit power of −41.25 dBm/MHz. Due to this relatively low-power, short-range nature of UWB, even a nominal degree of signal fading or interference could significantly impact signal integrity or transmission efficiency. Devices and systems implementing UWB must therefore attempt to optimize signal transmission strength to fully utilize the available power across the entire spectrum. As a practical matter, though, signal processing that is inherent in transmitter/receiver hardware (e.g., analog filter circuitry, antenna hardware) generally causes some degree of loss and results in non-optimal transmission power, especially along the outer ranges of the signal spectrum.

As a result, there is a need for a system that enables automatic or manual alteration of UWB data signals, having ability to selectively limit or augment one or more portions of a signal spectrum prior to transmission, providing optimal utilization and efficiency of UWB communications in an easy, efficient and cost-effective manner.

### SUMMARY OF THE INVENTION

The present invention provides a versatile system, comprising various structures and methods, for maximizing utilization and efficiency of ultra-wideband communications through pre-transmission signal shaping. The system of the present invention provides pre-equalization of UWB transmission signals. By the present invention, signals can be compensated, on a fixed or dynamic basis, to optimize transmission power across a signal spectrum. The system of the present invention also provides for selective alteration, again on a fixed or dynamic basis, of a transmission signal spectrum—providing wireless devices that may be adapted to varying, location-dependent regulatory requirements. The present invention is readily adaptable to a number of design requirements and variables—and may be implemented utilizing hardware already present in conventional wireless devices. The present invention thus provides efficient and reliable UWB data transmission in an easy, cost-effective manner.

Specifically, the present invention provides structures and methods that perform a digital pre-equalization of a UWB transmission signal spectrum. The present invention provides selective augmentation and reduction at multiple instances across the spectrum, utilizing existing device hardware. The present invention provides digital pre-equalization that compensates frequency shaping commonly introduced by transmission components (e.g., front-end filters, antenna equipment). The present invention provides control of a DC term at an IFFT input, enabling suppression of carrier leak-through. The present invention further provides spectral shaping of UWB emissions to either avoid certain victim receiver bands, or to limit emissions in these bands. The present invention recognizes and exploits the half duplex nature of UWB communications, to provide its benefits in an efficient architecture—one that utilizes circuitry commonly available in the receiver portion of many UWB transceiver devices.

More specifically, embodiments of the present invention provide various structures and methods of a system for selectively altering or shaping transmission signals in an ultra-wideband communications system. The system of the present invention provides a serial to parallel conversion function with a serial data input. The serial to parallel conversion function converts the serial data and outputs it in parallel format. An adjustment function receives the now parallel data and selectively alters the parallel data responsive to some code or vector. A frequency-to-time-domain conversion function receives the selectively altered parallel data, and prepares it for transmission over a wireless channel. A receiving device receives and decodes the altered parallel data transmission, completing the data transfer.

Other features and advantages of the present invention will be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 provides an illustration depicting one embodiment of a UWB communication system in accordance with certain aspects of the present invention;

FIG. 2 provides an illustration depicting another embodiment of a UWB communication system in accordance with certain aspects of the present invention;

FIG. 3 provides a diagram illustrating certain aspects of the present invention;

FIG. 4 provides another diagram illustrating certain aspects of the present invention; and

FIG. 5 provides an illustration depicting another embodiment of a UWB communication system in accordance with certain aspects of the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The present invention is hereafter illustratively described primarily in conjunction with the design and operation of an ultra-wideband (UWB) communications system. Certain aspects of the present invention are further detailed in relation to design and operation of multi-band Orthogonal Frequency Division Multiplexing (OFDM) communications system. Although described in relation to such structures, the teachings and embodiments of the present invention may be beneficially implemented with a variety of data transmission or communication systems or protocols (e.g., IEEE 802.11), depending upon the specific needs or requirements of such systems. The specific embodiments discussed herein are, therefore, merely demonstrative of specific ways to make and use the invention and do not limit the scope of the invention.

The present invention provides a versatile system of structures and methods that optimize utilization and efficiency levels of ultra-wideband communications, through pre-transmission signal shaping. The system of the present invention provides a digital pre-equalization of UWB transmission signals—providing selective augmentation and reduction at multiple instances across a UWB signal spectrum. The digital pre-equalization of the present invention compensates frequency shaping commonly introduced by transmission components (e.g., front-end filters, antenna equipment). The present invention provides control of a DC term at an IFFT input, enabling suppression of carrier leak-through. The present invention further provides spectral shaping of UWB emissions to either avoid certain victim receiver bands, or to limit emissions in these bands. The present invention recognizes and exploits the half duplex nature of UWB communications, to provide its benefits in an efficient architecture—one that utilizes circuitry commonly available in the receiver portion of many UWB transceiver devices.

As previously noted, the United States' Federal Communications Commission (FCC) has allocated the spectrum from 3.1 GHz-10.6 GHz for UWB radio transmissions. This UWB frequency allocation is unlicensed, leaving the spectrum open to a number of potentially conflicting technologies. UWB devices are allowed to transmit an average power of −41.25 dBm/MHz in this frequency band.

Due to the unlicensed nature of this spectrum, UWB devices have to contend with both incumbent and future services that share the spectrum. To enable coexistence, UWB devices should be capable of selectively controlling the emissions in certain conflicting (or “victim”) receiver bands. This also extends to compliance with global regulations that may require conformance to region-dependent spectral emission masks.

For purposes of explanation and illustration, certain aspects of the present invention are hereinafter described in reference to one type of UWB system—a multi-band OFDM system. The present invention provides a digital pre-equalization system for a multi-band OFDM communication system. By the present invention, the multi-band OFDM system may perform spectral shaping of its UWB emissions. The present invention provides transmitter pre-compensation of frequency distortions that may be introduced by system components—such as transmit filters and antenna hardware. The digital pre-equalization of the present invention provides interference avoidance, and enables implementation of a cognitive radio.

Commonly, UWB devices require implementation of wide bandwidth front-end filters, and antennas with very wide-band transmission characteristics. Unfortunately, frequency domain responses of such wide-band components are not generally flat. Thus, a transmitted signal from such a device has a non-flat spectrum. Additionally, ripples in the power spectral density of a transmitted signal will also result in a non-flat spectrum. Due to the applicable regulatory restrictions, the present invention recognizes that a transmitted signal spectrum must have an essentially flat response in order to maximize signal transmission power and the achievable range of device communication.

In certain applications, where frequency domain characteristics of certain front-end signal processing or transmission components are known beforehand, then the present invention may be utilized to digitally pre-tune or adjust a transmitted signal such that it has a relatively flat spectrum of OTA signal. Depending upon the nature of the components in the system and their operational characteristics, this adjustment may be a one-time, static adjustment, or in alternative embodiments, may comprise a dynamic, “real-time” adjustment. Either approach requires some characterization of the response of front-end components, whether that is an average response or a real-time determination. Once frequency response of front-end components has been characterized, this information can be stored in the digital base band on a configuration register (CFR), and thereby used to specify gain coefficients of the digital pre-equalizer.

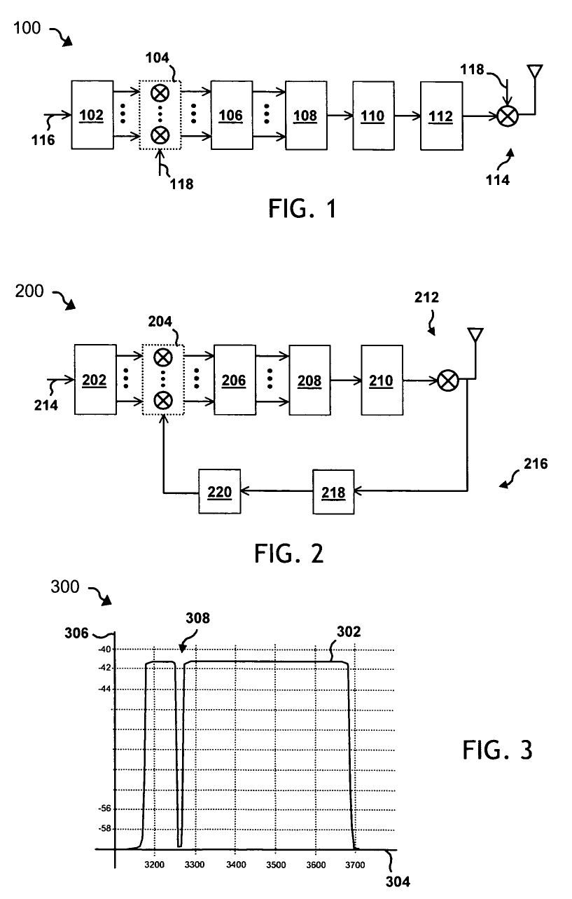

Referring now to FIG. 1, a block diagram of a UWB communication system 100 is illustrated. For purposes of illustration and explanation, system 100 is depicted as a multi-band OFDM system comprising a serial-to-parallel conversion function 102, a spectrum adjustment function 104, a frequency-to-time-domain conversion function 106 (e.g., an inverse fast Fourier transform—IFFT), a parallel-to-serial conversion function 108, a OFDM prefix/suffix function 110, a digital-to-analog conversion function 112, and some up conversion mixer function 114. In certain embodiments, encoded digital data bits are input 116 into function 102, converted to parallel format by function 102, and passed to spectrum adjustment function 104. Function 104 operates as a digital “pre-equalizer,” providing selective adjustment of specific data units (i.e., specific OFDM sub-carriers or tones). Function 104 may scale each OFDM sub-carrier, doing so at or before input to the IFFT 106. A desired weighting vector or required time-frequency code input 118 is provided to function 104 and to function 114.

In certain embodiments, pre-equalizer weighting vectors may be provided in order to compensate for a number of design or operational variables, or in order to comply with certain regulatory or industrial standards. Such vectors may provide, for example, weightings that are different for each OFDM sub-band. Furthermore, band usage patterns may be indicated to pre-equalizer function 104 by, for instance, a selected or pre-defined time-frequency code 118. Other similar variations and combinations are comprehended hereby.

As previously noted, a communication system is considered a UWB system if it occupies a minimum bandwidth of 500 MHz, at all times. In order to satisfy such a minimum bandwidth requirement, multi-band OFDM system 100 divides its signal transmission spectrum into multiple bands that are 528 MHz wide. In most conventional implementations of multi-band OFDM, no information is transmitted in the DC tone—which is the tone positioned in the center of the digital base band. This can result in a breaking of the power spectral density of each band into two parts—which violates regulatory requirements on minimum instantaneous bandwidth.

In certain UWB implementations, this issue may be avoided by transmitting a pseudo-random sequence in the DC tone. As a practical matter, however, a number of radio frequency (RF) implementations allow some degree of carrier leak through from an RF mixer. In order to comply with, for example, the FCC emission mask, the power of the carrier leak through should be less than −41.25 dBm/MHz. If this condition is violated, a UWB device must reduce its transmit power in order to ensure compliance. This has a negative impact across the entire transmit signal spectrum.

In systems utilizing the present invention, however, adjustment function 104 provides for digital suppression of carrier leak-through—obviating regulatory compliance issues without requiring cross-spectrum reductions in transmit power. In certain embodiments, for example, this may be provided by estimating the level of RF carrier leak-through during a calibration phase, injecting a DC tone at the input of the IFFT, and scaling the DC tone using adjustment function 104 to suppress the carrier leak-through. This is illustrated now in reference to FIG. 2, which depicts one embodiment of a multi-band OFDM system 200, implementing this suppression scheme in a manner according to the present invention. Similar to the embodiment depicted in FIG. 1, system 200 comprises a serial-to-parallel conversion function 202, a spectrum adjustment function 204, a frequency-to-time-domain conversion function 206 (e.g., an inverse fast Fourier transform—IFFT), a parallel-to-serial conversion function 208, a OFDM prefix/suffix function 210, and some up conversion mixer function 212. In certain embodiments, encoded digital data bits are input 214 into function 202, converted to parallel format by function 202, and passed to spectrum adjustment function 204. Function 204 operates as a digital “pre-equalizer,” providing selective adjustment of specific OFDM sub-carriers (or tones). Function 204 may scale each OFDM sub-carrier, doing so at or before input to the IFFT 206.

System 200 further comprises a carrier leak-through suppression function 216. Function 216 may be provided in the form of a feedback loop, a calibration phase, or some other suitable mechanism. Function 216 comprises a function 218 that measures RF carrier leak-through, and an analog-to-digital conversion (ADC) function 220. Function 216 determines—on a static, periodic or continual basis—an RF carrier leak-through value, and from that value derives an appropriate adjustment value for the gain of the DC tone. That adjustment value is provided as an input to adjustment function 204, which makes the appropriate corresponding change to the transmission signal spectrum (i.e., the DC tone).

As previously noted, UWB systems may be faced with a wide variety of different, changing, and even conflicting global spectral regulations or restrictions. In order for a UWB device or system to be commercially viable, it should be capable of meeting such disparate requirements. Since a multi-band OFDM system generates a transmitted signal in the frequency domain, varying or competing spectral requirements may be addressed by altering or sculpting a transmitted signal spectrum, in accordance with the present invention. The pre-equalization scheme provided by the present invention readily performs such flexible spectral shaping, and may be provided to do so on a fixed or dynamic basis. Thus, as a UWB device user roams from one region to another, the performance of the UWB device may be shifted on a real-time basis.

As previously noted, some national or regional regulatory bodies have specific requirements concerning specific frequency bands, and protecting those bands from interference. For example, Japanese regulatory authorities have certain requirements concerning the protection of radio astronomy bands that overlay the UWB spectrum. Those radio astronomy bands are: (3260-3267 MHz), (3332-3339 MHz), (3345.9-3352.5 MHz), (4825-4835 MHz), (4950-4990 MHz), (4990-5000 MHz), and (6650-6675.2 MHz).

Referring now to FIG. 3, a spectral diagram 300 illustrates the application of certain aspects of the present invention to the example listed above. Diagram 300 comprises a spectral plot line 302, which depicts a representative spectral band according to the present invention. Line 302 plots frequency, in MHz, along axis 304, against power spectral density, in dBm/MHz, along axis 306. Diagram 300 illustrates one embodiment of a spectral protection scheme that may be provided from the present invention. A multi-band OFDM transmission signal may be masked, negated or nullified at a desired frequency sub-range 308—by utilizing a spectrum adjustment function of the present invention to null out a desired group of sub-carriers. Thus, in the illustrative example depicted in FIG. 3, UWB emissions in the radio astronomy band between 3260 MHz-3267 MHz (i.e., range 308) may be reduced by an appropriate nullification value (e.g., ˜12 dB). This may be accomplished, for example, by negating or reducing 5 of the 128 sub-carriers that are utilized in a multi-band OFDM system. According to the present invention, coefficients corresponding to these tones may be set to zero within a spectrum adjustment function of the present invention. Accordingly, a receiver within such a multi-band OFDM system may disregard this relatively nominal degree of sub-carrier erasure—compensating for such erasure(s) with the forward error correction code.

The digital pre-equalization of the present invention also provides for optional scaling of spectral transmission power levels—in order to, for example, meet certain FCC emission requirements. For instance, some calibration circuitry may be provided and utilized to measure transmitted power of a signal as well as to determine how far that signal is from maximum possible (or allowable) emission(s). If the measured signal violates the relevant emission requirements (i.e., mask), a spectrum adjustment function of the present invention may be utilized to attenuate the signal, in the frequency domain, to ensure compliance with the requirement. Similarly, if the signal is well below the corresponding emissions mask, a spectrum adjustment function of the present invention may be utilized amplify the signal in the frequency domain—providing maximum transmit power, and correspondingly, maximum range. Such an approach may be readily adapted to optimize transmission in a number of applications, up to operational or performance limitations of certain system components (e.g., DAC resolution).

Additionally, the present invention may be applied to provide cognitive radio systems. Cognitive radio (CR) is a relatively new area of technology that has become of increasing interesting to a number of regulatory and standards organizations. For example, the United States' FCC has released proposals regarding, among other things, efficient spectral usage enabled by CR technology, and establishment of an interference temperature metric to quantify interference in victim receiver bands.

A multi-band OFDM system according to the present invention provides the ability to detect interference levels in specific victim receiver bands, and to easily shape a transmitted signal spectrum so as not to exceed a desired or defined interference level. According to the present invention, such functionality may be provided with minimal impact to hardware complexity. In certain embodiments of the present invention, a multi-band OFDM system employs an IFFT/FFT engine in its digital base band. As a UWB device, the system can determine average interference levels in various spectral bands by defining an interference-monitoring period (IMP). During an IMP, the system: performs an FFT operation on a received interference/noise signal; averages an energy value in each frequency bin; and determines a background interference/noise value in a selected victim receiver band. Consequently, the system's emissions in victim receiver band(s) of concern may be calculated and adjusted so as not to exceed an acceptable interference level. The spectrum adjustment function of the present invention may then be utilized to appropriately weight one or more sub-carriers at the input of the IFFT—thereby shaping the transmission spectrum of the multi-band OFDM UWB waveform.

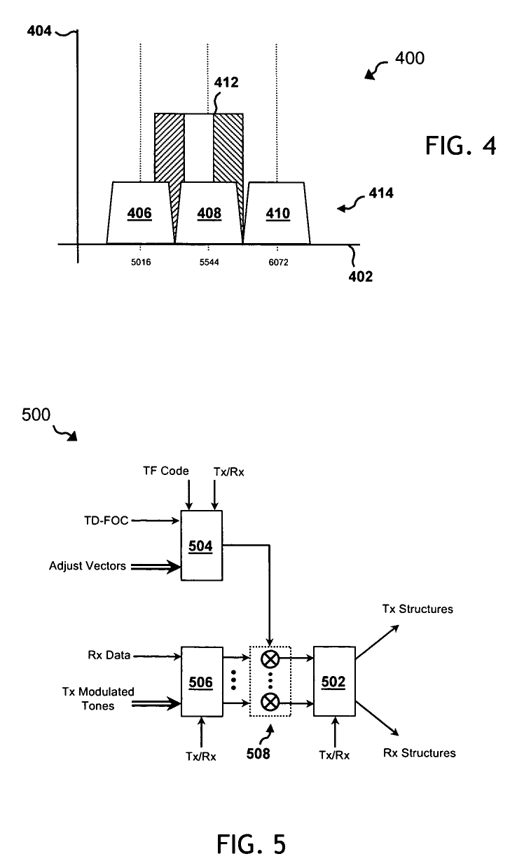

By way of illustration and example, this application of the present invention is described in greater detail now with reference to diagram 400, as depicted in FIG. 4. Diagram 400 representatively depicts certain aspects of a coexistence relationship between a multi-band OFDM device or system and an IEEE 802.11a (WLAN) device or system, according to the present invention. In this illustrative embodiment, cognitive radio techniques and a spectrum adjustment function are implemented in accordance with the present invention. Diagram 400 comprises a frequency axis 402, measured in MHz, and a relative power density axis 404, measured in dBm/MHz. Diagram 400 further comprises first, second and third OFDM frequency bands 406, 408 and 410, respectively, and a partitioned U-NII (IEEE 802.11a) band 412.

The multi-band OFDM system utilizes a band group 414, which comprises bands 406-410, operating between 4752 MHz and 6336 MHz. Group 414 overlaps with U-NII band 412 between 5150 MHz and 5825 MHz. An IEEE 802.15 selection criterion specifies certain parameters intended to ensure that UWB devices do not adversely impact IEEE 802.11a devices, while operating at a distance of 30 cm. Using this criterion, acceptable UWB interference in the victim receiver band (i.e., band 412) should be less than −88 dBm. This correlates to a UWB emissions mask of approximately −64 dBm/MHz—which is approximately 23 dB stricter than the FCC-specified UWB mask.

Thus, a multi-band OFDM system adhering to a UWB mask without benefit of the present invention would have to sacrifice approximately 675 MHz of its transmission spectrum that overlaps with band 412. If, however, that multi-band OFDM device is able to determine its impact on its closest WLAN device—and which IEEE 802.11a channel is utilized by that WLAN device—then the multi-band OFDM device can dynamically adjust its emissions in the victim receiver band. This requires that the multi-band OFDM device detect emissions in a victim receiver band, and estimate propagation loss from itself to that victim receiver.

By way of illustration and explanation, consider an IEEE 802.11a client device or system that is operating on one of four channels in a band between 5.15 GHz and 5.25 GHz. According to the standard, the maximum allowed transmit power of the client device is 40 mW (16 dBm). The signal strength in that 802.11a band at a corresponding multi-band OFDM (UWB) device receiver (i.e., interference) is given by:
P_{(INT)}^{UWB}=P_{(TX)}^{WLAN}−Path Loss. (1)
Similarly, the UWB interference in the victim receiver band (i.e., the WLAN device) is given by:
P_{(INT)}^{WLAN}=P_{(TX)}^{UWB}−Path Loss. (b 2)
In order to determine the impact of the UWB interference on the WLAN device, the propagation loss between the two devices needs is calculated. From equation (1), the propagation loss at the UWB receiver is calculated by computing the difference between the nominal 802.11a transmitted power (e.g., 15 dBm) and the received signal strength in the 802.11a channel. Once this propagation loss is calculated, the impact of the UWB transmission on the WLAN device is calculated from equation (2). From this, the required attenuation value for the UWB transmitter over the victim IEEE 802.11a channel is determined. Pre-equalization settings (i.e., in the spectrum adjustment function) for UWB sub-carriers that overlap with the IEEE 802.11a band are then appropriately configured to provide the desired or necessary level of coexistence.

According to the present invention, a spectrum adjustment function, and other related functional entities within a corresponding UWB system, may be implemented in a number of ways—combining various independent or integrated hardware or software constructs. For example, in certain embodiments of the present invention, a spectrum adjustment (or pre-equalization) function may be provided without adding hardware to a corresponding UWB system. In such embodiments, this may be achieved by, for example, reusing or sharing multiplier elements ahead of an IFFT/FFT block. This scheme is illustrated with reference now to UWB system segment 500, as depicted in FIG. 5.

As depicted, segment 500 comprises a multi-band OFDM UWB system—one that functions as a half-duplex transceiver. System 500 comprises an IFFT/FFT functional element 502, a first multiplexer 504, a second multiplexer 506, and a plurality of multiplier elements 508 interposed therebetween. In such a configuration, multiplier elements 508 are provided for time domain frequency offset correction (TD-FOC) in receiver operation. The present invention, however, also utilizes these multiplier elements for transmission operation. Thus, according to the present invention, elements 508 may be utilized in a full-duplex manner (i.e., for both receive and transmit operation) without adding hardware overhead to system 500.

In production of a device that embodies segment 500, multiplier elements generally dominate gate count—depending upon a number of variables (e.g., bit widths, design rules, process geometries). Such multiplier elements therefore usually comprise a significant portion of any hardware implementation, in terms of gate count or die size of a device. According to the present invention, however, multiplier elements that are already provided and allocated for a TD-FOC portion of the receiver are also utilized to provide a spectrum adjustment function for the transmitter. Thus, plurality 508 further constitutes a spectrum adjustment (or pre-equalization) function in accordance with the present invention. Performing the pre-equalization or spectral adjustment functions described hereinabove requires function 508 to perform multiplication of a complex and real quantities. As a result, one half the number of multipliers used in the TD-FOC of the receiver may be utilized for transmitter operation.

In this embodiment, the relative functional location of the multiplexer elements may be shifted to provide the desired operation—from, for example, a location (i.e., the input) within block 502 to an independent location preceding multipliers 508. Multiplexer 504 receives as inputs: a time-frequency code, a TD-FOC term, a transmit/receive indicator, and a set of one or more pre-equalization vectors (e.g., attenuation values, gain coefficients) provided in accordance with the description hereinabove. Multiplexer 506 receives as inputs: receiver data, transmission-modulated tones, and a transmit/receive indicator. For transmission mode, multiplexer 504 outputs, to function 508, multiplier values corresponding to its received pre-equalization vectors. Multiplexer 506 outputs each transmission-modulated tone to a corresponding multiplier within function 508. After each signal is adjusted as desired or required, function 508 outputs the now-altered signal to block 502 for completion of the transmit process. Thus, FIG. 5 illustratively depicts a structure where multipliers are being used for both TD-FOC and pre-equalization/adjustment processes. This cooperative utilization does not, however, increase overall complexity—providing improved system performance in an extremely efficient manner.

The functional elements of the components, functions or systems described hereinabove may be implemented in a variety of ways—relying on software, hardware, or combinations of both. Although depicted as separate functional instances, the constituent elements of the present invention may be integrated or combined as necessary or convenient for design purposes. For example, in the embodiment of FIG. 5, the multipliers may be implemented within the IFFT/FFT block. That embodiment may be implemented as a single semiconductor device, or may be provided as sub-portions of software operating with a processor. In other embodiments, functional elements may be provided via a compact chipset combining processor and software operations. Other combinations and alternatives, operating in accordance with the teachings of the present invention, are hereby comprehended.

The embodiments and examples set forth herein are therefore presented to best explain the present invention and its practical application, and to thereby enable those skilled in the art to make and utilize the invention. However, those skilled in the art will recognize that the foregoing description and examples have been presented for the purpose of illustration and example only. For example, aspects of the present invention have been described above in relation to UWB transceiver systems. The teachings and principles of the present invention are also applicable or adaptable to other communications protocols (e.g., IEEE 802.11, IEEE 802.16). The description as set forth herein is therefore not intended to be exhaustive or to limit the invention to the precise form disclosed. As stated throughout, many modifications and variations are possible in light of the above teaching without departing from the spirit and scope of the following claims.

1. An ultra-wideband wireless communications system comprising:
a serial data input;
a serial to parallel conversion function, adapted to receive serial data from the serial data input and to output parallel data;
an adjustment function, adapted to receive parallel data from the serial to parallel conversion function and to selectively alter the parallel data; and
a frequency-to-time-domain conversion function, adapted to receive selectively altered parallel data from the adjustment function and to prepare the selectively altered parallel data for transmission over a wireless channel.

2. The system of claim 1, wherein the ultra-wideband wireless communications system comprises a multi-band orthogonal frequency division multiplexing system.

3. The system of claim 1, wherein the ultra-wideband wireless communications system comprises a system operating between 3.1 gigahertz and 10.6 gigahertz.

4. The system of claim 1, wherein the adjustment function comprises one or more multipliers adapted to alter gain of a signal.

5. The system of claim 4, wherein the adjustment function further comprises one or more multipliers adapted to selectively alter gain of a plurality of signal sub-bands, based on a respective plurality of weighting vectors.

6. The system of claim 1, wherein the frequency-to-time-domain conversion function comprises an inverse fast Fourier transform.

7. The system of claim 6, wherein the adjustment function comprises one or more multipliers implemented with the frequency-to-time-domain conversion function.

8. The system of claim 1, wherein the ultra-wideband wireless communications system further comprises a carrier leak-through suppression function.

9. The system of claim 8, wherein the carrier leak-through suppression function further comprises a feedback loop from an up conversion mixer function to the adjustment function.

10. The system of claim 8, wherein the carrier leak-through suppression function is dynamic.

11. A method of transmitting data in a multi-band orthogonal frequency division multiplexing system, the method comprising the steps of:
providing digital data in a serial format;
converting the serial digital data to parallel digital data units;
selectively altering a parallel digital data unit;
converting the selectively altered parallel digital data unit from a frequency domain into a time domain; and
transmitting the selectively altered parallel digital data in a time domain over a wireless channel to a receiver.

12. The method of claim 11, wherein the step of converting the serial digital data to parallel digital data units further comprises converting the serial digital data to an orthogonal frequency division multiplexing sub-carrier.

13. The method of claim 11, wherein the step of selectively altering a parallel digital data unit further comprises selectively increasing the gain of the parallel digital data unit.

14. The method of claim 11, wherein the step of selectively altering a parallel digital data unit further comprises selectively decreasing the gain of the parallel digital data unit.

15. The method of claim 11, wherein the step of selectively altering a parallel digital data unit further comprises selectively altering a parallel digital data unit responsive to a calibration process.

16. A versatile system for altering the transmission signal profile of a multi-band orthogonal frequency division multiplexing system data tone, the system comprising:
a serially input data tone;
a serial to parallel conversion function, that receives serially input data tone and converts it to a parallel data tone;
an adjustment function that receives the parallel data tone and selectively modifies the parallel data tone, responsive to an adjustment vector, to render an adjusted data tone;
a frequency to time domain conversion function that receives the adjusted data tone and prepares converts the adjusted data tone into the time domain; and
a wireless communication channel, across which the adjusted data tone is transmitted in the time domain.

17. The system of claim 16, wherein the adjustment vector is selected to suppress carrier leak-through.

18. The system of claim 16, wherein the adjustment vector is selected to optimize sub-tone transmission power.

19. The system of claim 16, wherein the adjustment vector is selected to nullify a desired sub-tone.

20. The system of claim 16, wherein the adjustment function cooperatively utilizes half-duplex receiver circuitry in a full duplex manner.

21. The system of claim 20, wherein the adjustment function cooperatively utilizes time-domain frequency offset correction circuitry.
